(19) United States
(12) Patent Application Publication
(10) Pub. No.: US 2026/0100559 A1
(43) Pub. Date: Apr. 9, 2026

(54) INTERACTION MODULE FOR A SWITCH CABINET-FREE AUTOMATION SYSTEM OF AN INDUSTRIAL PLANT

(71) Applicant: Murrelektronik GmbH, Oppenweiler (DE)

(72) Inventors: Olaf Prein, Oppenweiler (DE); Jan Aumüller, Oppenweiler (DE)

(21) Appl. No.: 19/325,745

(22) Filed: Sep. 11, 2025

(30) Foreign Application Priority Data
Oct. 9, 2024 (EP) 24 205 450.0

(51) Int. Cl. H02B 1/04

(52) U.S. Cl. CPC H02B 1/04

(57) ABSTRACT

An interaction module for a switch cabinet-free automation system of an industrial plant. The interaction module includes a housing and a plug connection component for the electrical and/or mechanical connection to a base of the switch cabinet-free automation system. Furthermore, the interaction module has an output element which is arranged in or on the housing and is configured to output an optical and/or acoustic signal which signals a status of the industrial plant. Alternatively or additionally, the interaction module has an input element which is arranged in or on the housing and via which an input for controlling the industrial plant can be made. Furthermore, a switch cabinet-free automation system is described.

### FIELD OF THE DISCLOSURE

Embodiments of the present disclosure relate to an interaction module for a switch cabinet-free automation system of an industrial plant. Furthermore, embodiments of the present disclosure relate to a switch cabinet-free automation system.

### BACKGROUND

Many industrial plants have a switch cabinet in which the central control elements for plant control are located.

In modern plants in particular, the functions of the switch cabinet are however increasingly relocated to the field. In recent years, technology has advanced such that it is possible to control entire plants using modular switch cabinet-free automation systems.

The known switch cabinet-free automation systems are usually equipped with a plurality of functional and/or supply modules which are arranged so as to be distributed throughout the plant and each perform different tasks and/or control different parts of the plant.

However, the design and maintenance of modern switch cabinet-free automation systems is often complex and, compared to conventional switch cabinet-based systems, involves increased effort and higher costs. The use of modern switch cabinet-free automation systems is also often limited to simple control tasks.

Accordingly, there is a need to overcome the disadvantages of switch cabinet-free automation systems known from the prior art.

### SUMMARY

Embodiments of the present disclosure provide an interaction module for a switch cabinet-free automation system of an industrial plant, comprising a housing and a plug connection component for the electrical and/or mechanical connection to a base of the switch cabinet-free automation system. The interaction module has an output element which is arranged in or on the housing and is configured to emit an optical and/or acoustic signal which signals a status of the industrial plant. Alternatively or additionally, the switch cabinet-free interaction module also has an input element which is arranged in or on the housing and via which an input for controlling the industrial plant can be made.

The output element and/or the input element allow additional functions to be integrated into the switch cabinet-free automation system, in particular display and operating functions for the plant and/or maintenance personnel.

In other words, the use of the interaction module according to the present disclosure may thus extend the range of applications of automation systems, in particular of switch cabinet-free automation systems. In addition to functional and supply modules, the interaction module according to the present disclosure also allows operating functions, through which the plant personnel can interact with the industrial plant, and signaling functions for the plant personnel to be provided. These additional functions can also be combined in a single component, as a result of which hardware and costs can in turn be saved.

The housing is formed, for example, from a housing body and a housing cover. The output element and/or the input element may be arranged in or on the housing cover. The plug connection component is arranged, for example, on the housing body, in particular on a side facing away from the housing cover. Due to this design, the entire interaction module is quick and relatively easy to replace from a technical standpoint. At the same time, the arrangement of the output element and/or the input element on the housing cover ensures good accessibility for plant personnel.

The housing cover is in particular plugged onto the housing body and/or fastened to the housing body using a fastening means. The output element and/or the input element, in turn, may be connected to a printed circuit board and/or electronics housed in the housing by means of a plug contact and/or a flat ribbon cable. This design is technically easy to implement and, if necessary, allows the housing cover to be replaced very easily together with the output element and/or the input element.

In one variant embodiment of the interaction module, the output element comprises at least one signal light which is designed to output an operating status, a production instruction, a safety instruction and/or an alarm for workers of the industrial plant, in particular to signal this optically. In other words, the output element comprising the at least one signal light emits an optical signal.

The signal light can be designed to be single-colored or multi-colored. In addition, the signal light can be designed to emit a steady light and/or a flashing light as a signal.

In simple terms, the signal light of the interaction module can be used to map the functions of conventional information or warning lights. This eliminates the need for the use and often complex connection of information or warning lights designed as separate components to the automation system.

The signal light is, for example, a surface light which extends over part of one side of the housing, in particular over at least 20%, for example over more than 50%, e.g. over more than 80% of the side surface. This ensures good visibility and thus accessibility of information for plant personnel, even if it is not in the immediate vicinity of the interaction module.

In a further variant embodiment of the interaction module, part of the housing is configured to be transparent or translucent so that light from the signal light can be coupled out of the housing via the part of the housing. Accordingly, the signal light can be arranged inside the housing and still emit light signals into the environment. It is therefore not necessary to provide openings in the housing for the emission of light signals. The signal light is thus housed in a protected manner, and the entire interaction module can have a closed or sealed housing, making it versatile, especially also in environments having higher requirements as to the protection class, IP65 or IP67, for example.

The interaction module may also comprise a plurality of signal lights arranged on different sides of the housing so that the signal lights can emit light in different spatial directions. Since the signals can be output in several spatial directions, the recipient circle can be enlarged, ensuring that the signals are perceived.

It is further conceivable that the output element comprises at least one display which is designed to display at least one symbol for signal output. A variety of different information and/or instructions can be output via the display. In particular, the display can also be used to output instructions for action which must be followed by the plant personnel.

The display is, for example, an electrophoresis-based display. In particular, it can be designed as electronic paper. This is a type of bistable display which can store an image without power and only requires energy to change the display state. Displays of this type are also known under the terms e-paper, E-Paper, ePaper, E-Ink, P-Ink, and other names. It is furthermore conceivable that the display is designed as a bistable LCD display and/or operates on the principle of micromechanically controlled interference modulation.

The design of the display as electronic paper has the advantage that information can be displayed for signal output even in a de-energized state. In particular, it is therefore possible to display an instruction for action which is still available to plant personnel even if the industrial plant has been disconnected (at least partially) from the power supply due to a defect.

It may also be provided that the display comprises a backlight, in particular wherein a light color of the backlight is variable for outputting the optical signal. This allows the display itself to be used as an information or warning light, for example to communicate certain plant operating states to persons further away from the interaction module by means of the color and/or to warn them.

In principle, the signal colors typical for industrial plants can be used as colors, i.e., red, yellow, orange, green, blue, white, and magenta. The different colors can thus be used to display appropriate information directly to the plant personnel, in particular with regard to the status of the industrial plant.

The display can also be designed as a touch display or as a touchscreen. This has the advantage that operating elements can be displayed graphically and changed depending on the situation. In this context, it is also conceivable that the display has means for changing the display and/or output settings. For example, a language package may be provided by means of which the language of the displayed operating elements can be changed.

The input element is, for example, an input element which is to be operated manually. It can be arranged together with a plurality of further input elements on a printed circuit board, wherein the input elements are connected by a bus as a matrix or directly to electronics that are for example arranged in the housing. This design is technically easy to implement.

Furthermore disclosed is a switch cabinet-free automation system for an industrial plant, comprising a base and at least one interaction module according to the present disclosure, wherein the interaction module is electrically and/or mechanically connected to the base via the plug connection component. The advantages discussed above for the interaction module apply equally to the switch cabinet-free automation system.

In a variant of the switch cabinet-free automation system, the base is designed as a plug-in plate for receiving the interaction module and further pluggable modules. This allows for particularly easy integration of additional modules and/or replacement of existing modules. As already explained above, the modules may be functional and/or supply modules.

It may be provided that the base has a plurality of communication lines and conductors for carrying low voltage and/or conductors for carrying extra-low voltage, and that the plug connection component is configured to establish a data connection between the interaction module and the communication lines of the base and/or to establish an electrical connection to the extra low-voltage and/or low voltage-carrying conductors of the base when the interaction module is plugged onto the base or plugged into the base.

Low voltage refers to an alternating voltage of 1,000 V or less, in particular between 50 V and 1,000 V, or a direct voltage of 1,500 V or less, in particular between 75 V and 1,500 V. In contrast thereto, extra-low voltage refers to an alternating voltage of 50 V or less or a direct voltage of 120 V or less, in particular 75 V and less.

The conductors for carrying low voltage are in particular designed to carry an alternating voltage of 110 V, 230 V or 400 V or a direct voltage in the range from 400 V to 800 V.

The conductors for carrying extra-low voltage are in particular designed to carry a direct voltage of 24 V or 48 V.

The interaction module can be supplied with power via the conductors for carrying low voltage and/or the conductors for carrying extra-low voltage. In particular, the interaction module can also be supplied with power exclusively by extra-low voltage and the conductors provided for this purpose. This has the advantage that additional protection against contact is not required.

Both the power supply of the interaction module and data connections to further modules and/or external systems may be established by simply plugging the interaction module onto the base.

In a further variant, the switch cabinet-free automation system has at least one additional interaction module according to the present disclosure. A total of at least two interaction modules are therefore provided.

The two interaction modules may be arranged at opposite ends of the base and, in particular, each form outermost modules of a row of modules arranged along the base.

This allows signals to be output in opposite spatial directions by means of the output elements of the respective interaction modules, which in turn improves overall signal accessibility. In simple terms, the signal output in opposite directions allows a larger number of potential receivers to be reached. In particular, this also provides greater independence from the installation situation at the application site.

In a further embodiment, the switch cabinet-free automation system comprises at least one further base having an interaction module according to the present disclosure. Thus, at least two bases are provided, each comprising at least one interaction module.

To further improve signal accessibility and/or further increase the receiver horizon, it may be provided that the bases are arranged at a distance from each other and are coupled to each other via a data connection so that interdependent and/or coordinated optical and/or acoustic signals can be output at different positions of the industrial plant by means of the interaction modules arranged on the different bases.

It may also be provided that the interaction module of a base has a light sensor or that a light sensor module having a light sensor is present at the base, the light sensor being set up to receive the optical signal of the interaction module of the other base. This enables communication between the bases without the need for a separate data connection, in particular without a wired connection or a wireless data connection such as WLAN or similar. Communication between the bases is therefore based (exclusively) on the optical signals.

### BRIEF DESCRIPTION OF THE DRAWINGS

Further features and advantages will become apparent from the description below and from the accompanying drawings, to which reference is made and in which:

FIG. 1 shows a schematic representation of a switch cabinet-free automation system according to a first embodiment of the present disclosure;

FIG. 2 shows a schematic representation of a switch cabinet-free automation system according to a second embodiment of the present disclosure; and

FIG. 3 shows a schematic representation of a switch cabinet-free automation system according to a third embodiment of the present disclosure.

### DETAILED DESCRIPTION OF THE DRAWINGS

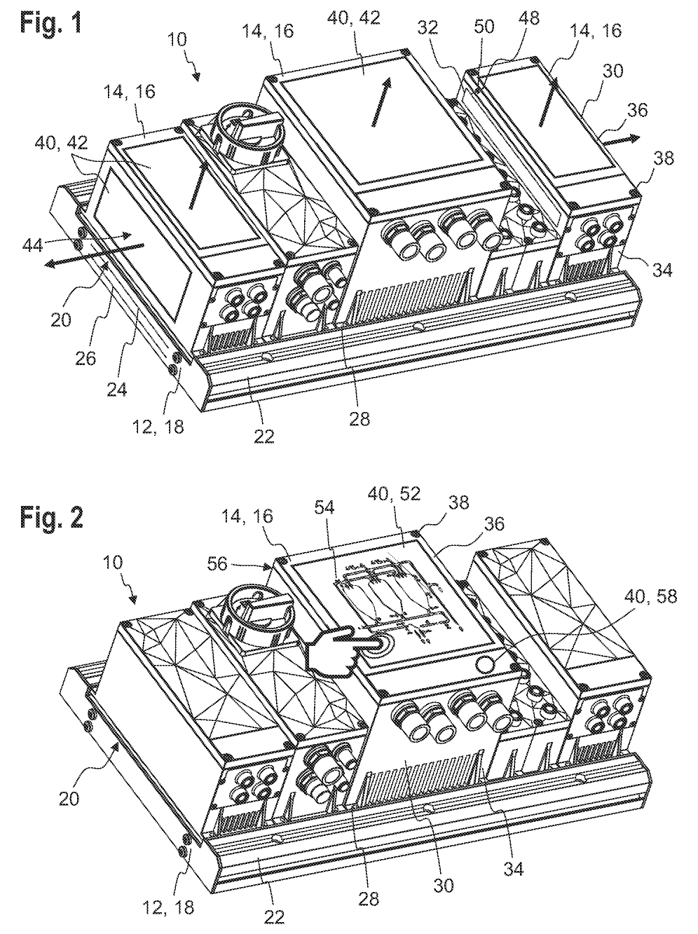

FIG. 1 schematically shows an example embodiment of a switch cabinet-free automation system 10 according to the present disclosure for an industrial plant.

The switch cabinet-free automation system 10 comprises a base 12 and six modules 14 arranged in a row along the base 12. Three of the six modules 14 are interaction modules 16 according to the present disclosure. The other modules 14 are, for example, a functional module and a supply module.

In the example embodiment, the interaction modules 16 according to the present disclosure are provided in the middle and at the ends of the modules 14 arranged in a row. In the present case, the row extends over the entire length of the base 12, so that the interaction modules 16 terminating the row are arranged at opposite ends of the base 12. However, it may basically also be provided that the base 12 has free spaces so that the base 12 can be expanded by modules 14.

In the variant shown, the base 12 is designed as a plug-in plate 18.

The modules 14, in particular the interaction modules 16, each have at least one plug connection component 20 by means of which they are mechanically and electrically connected to the base 12. This is achieved in a simple manner by inserting the modules 14 into the base 12 via their respective plug connection component 20, i.e., into a free slot of the plug-in plate 18.

In this context, mechanically connected means that the interaction modules 16 are each firmly fixed to the base 12 by means of their plug connection components 20. Accidental disconnection of the modules 14, in particular the interaction modules 16, is therefore not possible.

In FIG. 1, all modules 14 are connected to the base 12 by plug connections formed by the respective plug connection components 20 of the modules 14 and corresponding engagement geometries of the base 12. The plug connections are realized, for example, by interlocking pins and holes in the respective counterparts. In other words, the plug connection components 20 can be designed as pins and/or holes.

Alternatively or additionally, it is also possible for the base 12 to have a frame 22 into which the modules 14 are inserted or plugged. The modules 14 can be arranged adjacent to one another to stabilize each other. Alternatively, however, a distance between the individual modules 14 may also be provided, in particular to improve heat dissipation from the individual modules 14. In principle, such connections are also to be understood as plug connections within the meaning of the present disclosure. In these cases, the plug connection components 20 of the interaction modules 16 can be formed by the three-dimensional shape of the interaction modules 16 themselves.

The plug connections can also be implemented via sockets and plug connectors, which simultaneously ensure the mechanical connection and the electrical connection.

Of course, the type of plug connection is not to be understood in a restrictive manner. Many other types of plug connections are conceivable.

In the example embodiment, the base 12 has a plurality of communication lines 24 and electrical conductors 26 for carrying an extra-low voltage.

In the example embodiment, the plug connection components 20 of the respective interaction modules 16 are configured to establish data connections between the interaction modules 16 and the base 12, in particular with the communication lines 24 arranged in the base 12.

In addition, the plug connection components 20 of the interaction modules 16 are each configured to establish at least one electrical connection to the base 12, in particular to the electrical conductors 26 arranged in the base 12. The interaction modules 16 plugged onto the base 12 can be supplied with electrical energy, in particular with voltages in the extra low-voltage range, via the electrical connections, if required.

In the example embodiment, the modules 14, in particular the interaction modules 16, are additionally fixed to the base 12 by retaining elements 28 to ensure a secure hold. In the variant embodiment shown, the retaining elements 28 are formed by projections at the corners of the respective modules 14, which protrude laterally and have openings therein. For fastening to the base 12, fastening elements, for example screws, are inserted into the respective openings and fastened to the base 12, in particular by screwing.

The interaction modules 16 shown in FIG. 1, which are plugged onto the base 12, each have a housing 30 and electronics 32 arranged therein.

The housings 30 are each formed by a housing body 34 and a housing cover 36 arranged on the housing body 34, which is, for example, plugged thereon. In the variant shown in FIG. 1, the housing covers 36 are additionally fixed to the housing body 34 by fastening means 38, for example by screws.

The plug connection components 20 are each arranged on the housing body 34. In particular, the plug connection components 20 and the housing covers 36 are arranged on opposite sides of the respective housings 30.

The interaction modules 16 shown in FIG. 1, which are plugged onto the base 12, also each comprise at least one output element 40, which is arranged in or on the housing 30 and is configured to output an optical signal which signals a status of the industrial plant.

For this purpose, the output elements 40 of the interaction modules 16 each have at least one signal light 42 by means of which an operating status of the industrial plant, a production instruction, a safety instruction, and/or an alarm for workers of the industrial plant can be displayed. For example, the signal can be output by light of a specific color or by a flashing pattern.

Optionally, in one or more of the interaction modules 16, at least part of the housing 30 can be configured to be transparent or translucent and the signal light 42 can be arranged inside the housing 30 so that light from the signal light 42 can be coupled out of the housing 30 via the part configured to be transparent or translucent.

The output elements 40 of the interaction modules 16 are arranged, for example, on side walls 44 of the respective housings 30 or in or on the housing cover 36.

In the interaction modules 16 shown in FIG. 1, the signal lights 42 are each designed as surface lights.

The signal lights 42 can be designed in the same color or in multiple colors and/or divided into multiple segments.

In particular, the signal lights 42 can also be designed to display light effects or symbols for signal output.

The interaction module 16 located in the middle of the row has a signal light 42 which is arranged on the housing cover 36 and occupies 80% of the cover surface. This allows the optical signals output to be easily perceived even by persons standing at a great distance. This is, of course, not to be understood in a restrictive manner. Variant embodiments are also conceivable in which the signal light 42 occupies 100% of the cover surface, as a result of which particularly good visibility is achieved. However, it is also possible for the signal light 42 to occupy only 20% of the cover surface. Signal lights 42 in this size range can serve, for example, as marking signs, in particular for identifying input elements 62.

The interaction modules 16 located at the ends of the row each have two signal lights 42, one of which is arranged on the housing cover 36 and one on a side wall 44 of the housing 30. These signal lights 42 also each extend over at least 20%, for example over 80%, of the cover surface or side surface of the housing 30. This arrangement allows optical signals to be emitted in different spatial directions by means of the output elements 40, as symbolized by arrows in FIG. 1.

The lateral signal lights 42 of the two interaction modules 16 arranged at the ends of the row are arranged relative to each other such that they can emit optical signals in opposite spatial directions. This enlarges the circle of potential signal receivers.

In at least one of the interaction modules 16, the output element 40 arranged on the housing cover 36 is connected to the electronics 32 arranged in the housing 30 by means of a flat ribbon cable 48 and a plug contact 50. This makes the output element 40 particularly easy to replace by removing the housing cover 36 and disconnecting the plug contact 50.

FIG. 2 shows a schematic representation of a switch cabinet-free automation system 10 according to a second embodiment of the present disclosure. This essentially corresponds to the variant shown in FIG. 1, so that only the differences will be discussed below. Identical or functionally identical components are marked with the same reference numerals.

The switch cabinet-free automation system 10 shown in FIG. 2 has an interaction module 16 according to the present disclosure which has an output element 40. The output element 40 comprises a display 52 which can display at least one symbol 54 for signal output. Compared to the variant shown in FIG. 1, this expands the number of signaling options.

In the example embodiment, the display 52 has a backlight 56 the light color of which can be changed to output the optical signal. For example, the display 52 can be backlit in red to output an error or a warning, or in green to signal a normal status of the plant. An advantage of this design is that the light color is still perceivable to persons at greater distances ,and thus a very long signal range can be realized.

Alternatively or additionally to the optical output element 40, at least one acoustic output element 40, for example a loudspeaker 58, can also be provided for signal output.

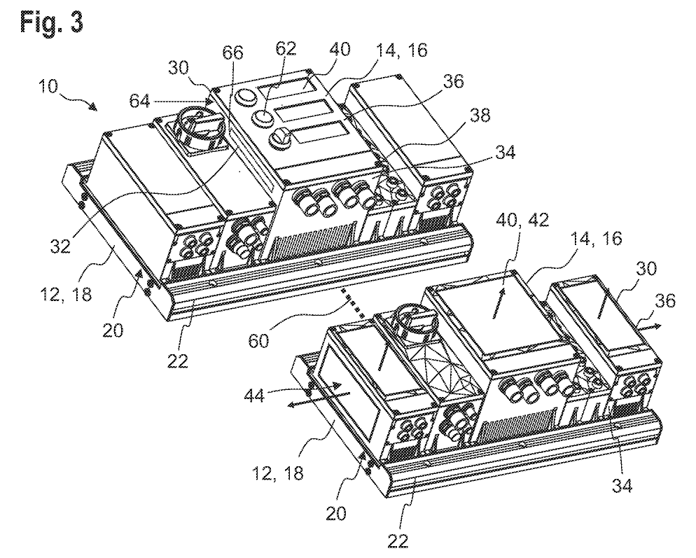

FIG. 3 shows a schematic representation of a switch cabinet-free automation system 10 according to a third embodiment of the present disclosure. This essentially corresponds to the variants shown in FIG. 1 and FIG. 2, so that only the differences will be discussed below. Identical or functionally identical components are marked with the same reference numerals.

The switch cabinet-free automation system 10 shown in FIG. 3 comprises a further base 12 having interaction modules 16.

The bases 12 are arranged spaced apart from each other and coupled to each other via a data connection 60, so that interdependent and/or coordinated optical and/or acoustic signals can be output at different positions of the industrial plant by means of the interaction modules 16 arranged on the different bases 12.

One of the interaction modules 16 shown in FIG. 3 has a plurality of manually operable input elements 62, via which manual inputs can be made to control the industrial plant.

The input elements 62 are arranged on a printed circuit board 64 and connected by a bus 66 to the electronics 32 arranged in the housing 30.

Of course, a plurality of input elements 62 and output elements 40, which are arranged, for example, on a common printed circuit board 64, can also be provided in an interaction module 16.

This allows signals to be output directly from the interaction module 16 or the switch cabinet-free automation system 10 and commands to be entered directly.

The example embodiments shown in the figures are not to be understood in a restrictive manner, but rather as exemplary embodiments.

1. An interaction module for a switch cabinet-free automation system of an industrial plant, comprising a housing and a plug connection component for the electrical and/or mechanical connection to a base of the switch cabinet-free automation system, wherein the interaction module comprises an output element which is arranged in or on the housing and is configured to output an optical and/or acoustic signal which signals a status of the industrial plant, and/or wherein the interaction module has an input element which is arranged in or on the housing and via which an input for controlling the industrial plant can be made.

2. The interaction module according to claim 1, wherein the housing is formed by a housing body and a housing cover, and wherein the output element and/or the input element is arranged in or on the housing cover.

3. The interaction module according to claim 2, wherein the plug connection component is arranged on the housing body.

4. The interaction module according to claim 2, wherein the housing cover is plugged onto the housing body and/or fastened to the housing body using a fastening means, and wherein the output element and/or the input element is connected by a plug contact and/or a flat ribbon cable to electronics accommodated in the housing.

5. The interaction module according to claim 1, wherein the output element comprises at least one signal light which is configured to output an operating status, a production instruction, a safety instruction and/or an alarm for workers of the industrial plant.

6. The interaction module according to claim 5, wherein the signal light is a surface light extending over part of one side of the housing.

7. The interaction module according to claim 6, wherein the signal light is extending over at least 20% of the side surface.

8. The interaction module according to claim 7, wherein the signal light is extending over more than 50% of the side surface.

9. The interaction module according to claim 5, wherein at least part of the housing is designed to be transparent or translucent so that light from the signal light can be coupled out of the housing via the part of the housing.

10. The interaction module according to claim 5, comprising at least one further signal light, wherein the signal lights are arranged on different sides of the housing so that the signal lights emit light in different spatial directions.

11. The interaction module according to claim 1, wherein the output element comprises at least one display which is configured to display at least one symbol for signal output.

12. The interaction module according to claim 11, wherein the display comprises a backlight, wherein a light color of the backlight is variable for outputting the optical signal.

13. The interaction module according to claim 1, wherein the input element is an input element which is to be operated manually.

14. The interaction module according to claim 13, wherein the input element is arranged together with a plurality of further input elements on a printed circuit board, wherein the input elements are connected by a bus to electronics arranged in the housing.

15. A switch cabinet-free automation system for an industrial plant, comprising a base and at least one interaction module according to claim 1, wherein the interaction module is electrically and/or mechanically connected to the base via the plug connection component.

16. The switch cabinet-free automation system according to claim 15, wherein the base is designed as a plug-in plate for receiving the interaction module and further pluggable modules.

17. The switch cabinet-free automation system according to claim 15, wherein the base has a plurality of communication lines and conductors for carrying low voltage and/or conductors for carrying extra-low voltage, and wherein the plug connection component is configured to establish a data connection between the interaction module and the communication lines of the base and/or to establish an electrical connection to the extra low-voltage and/or low voltage-carrying conductors of the base when the interaction module is plugged onto the base or plugged into the base.

18. The switch cabinet-free automation system according to claim 15, comprising a further interaction module according to claim 1, wherein the interaction modules are arranged at opposite ends of the base.

19. The switch cabinet-free automation system according to claim 18, wherein the interaction modules each form outermost modules of a row of modules arranged along the base.

20. The switch cabinet-free automation system according to claim 15, comprising at least one further base having an interaction module according to claim 1, wherein the bases are arranged at a distance from each other and are coupled via a data connection so that interdependent and/or coordinated optical and/or acoustic signals can be output at different positions of the industrial plant by means of the interaction modules arranged on the different bases.
